(19) United States
(12) Patent Application Publication
(10) Pub. No.: US 2010/0052492 A1
(43) Pub. Date: Mar. 4, 2010

(54) EXPOSURE DEVICE AND LIGHT-EMITTING DEVICE

(75) Inventor: Michiaki Murata, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/391,311

(22) Filed: Feb. 24, 2009

(30) Foreign Application Priority Data
Aug. 29, 2008 (JP) 2008-221535

(51) Int. Cl. H01J 61/92

(52) U.S. Cl. 313/1

(57) ABSTRACT

The exposure device that exposes a charged image carrier includes: a light-emitting chip on which light-emitting elements are arrayed in a first scan direction; and a circuit board on which the light-emitting chip is mounted and that includes wiring electrically connected to the light-emitting chip. The light-emitting chip includes: a light-emitting element chip including a first substrate and the light-emitting elements on one surface of the first substrate; a drive element chip including a second substrate, a drive element on the second substrate driving the light-emitting elements and a penetration hole in the second substrate; a first connecting member electrically connecting the light-emitting elements to the drive element, while the light-emitting elements face the penetration hole; and a second connecting member electrically connecting the drive element to the wiring, while a mounting surface of the drive element chip for fixing the light-emitting element chip faces the circuit board.

### CROSS REFERENCE TO RELATED APPLICATIONS

This application is based on and claims priority under 35 USC §119 from Japanese Patent Application No. 2008-221535 filed Aug. 29, 2008.

### BACKGROUND

1. Technical Field

The present invention relates to an exposure device including multiple light-emitting elements, and a light-emitting device.

2. Related Art

Recently, an exposure device using a light-emitting element array has been employed in an electrophotographic image forming apparatus such as a printer or a copy machine. Here, the exposure device exposes the surface of an image carrier such as a photoconductor drum, and the light-emitting element array is formed of light-emitting elements such as light-emitting diodes (LEDs) arrayed in a line. Typically, such an exposure device is provided with a circuit for driving these multiple light-emitting elements in addition to the light-emitting elements.

### SUMMARY

According to an aspect of the invention, there is provided an exposure device that exposes a charged image carrier, including: a light-emitting chip on which plural light-emitting elements are arrayed in a first scan direction; and a circuit board on which the light-emitting chip is mounted, the circuit board including wiring electrically connected to the light-emitting chip, the light-emitting chip including: a light-emitting element chip that includes a first substrate and the plurality of light-emitting elements formed on one surface of the first substrate; a drive element chip that includes a second substrate, a drive element formed on the second substrate and a portion defining a penetration hole formed in the second substrate, the drive element driving the plurality of light-emitting elements provided to the light-emitting element chip; a first connecting member that electrically connects the plurality of light-emitting elements provided on the one surface of the first substrate of the light-emitting element chip to the drive element provided to the drive element chip, in a state where the plurality of light-emitting elements face the portion defining the penetration hole formed in the drive element chip; and a second connecting member that electrically connects the drive element provided to the drive element chip to the wiring provided to the circuit board, in a state where a mounting surface of the drive element chip faces the circuit board, the light-emitting element chip being fixed to the mounting surface.

### BRIEF DESCRIPTION OF THE DRAWINGS

Exemplary embodiment (s) of the present invention will be described in detail based on the following figures, wherein:

FIG. 1 shows an example of an overall configuration of an image forming apparatus to which the exemplary embodiment is applied;

FIG. 2 is a cross-sectional view showing a structure of the LPH;

FIG. 3A is a top view of the light-emitting unit of the LPH;

FIG. 3B is a top view of the rod lens array and the holder of the LPH;

FIG. 4 is an enlarged view of a region in which the light-emitting chips are connected in the light-emitting portion of the light-emitting unit;

FIG. 5 is a cross-sectional view of the light-emitting unit;

FIG. 6 is an exploded cross-sectional view of the light-emitting unit;

FIG. 7 shows the light-emitting element chip viewed from the light-emitting surface side;

FIG. 8 shows the drive element chip viewed from the mount surface side;

FIG. 9 is a cross-sectional view of the light-emitting chip; and

FIG. 10 shows light paths of the light beams emitted by one of the LEDs provided to the light-emitting element chip.

### DETAILED DESCRIPTION

Hereinafter, a detailed description will be given of an exemplary embodiment of the present invention with reference to the accompanying drawings.

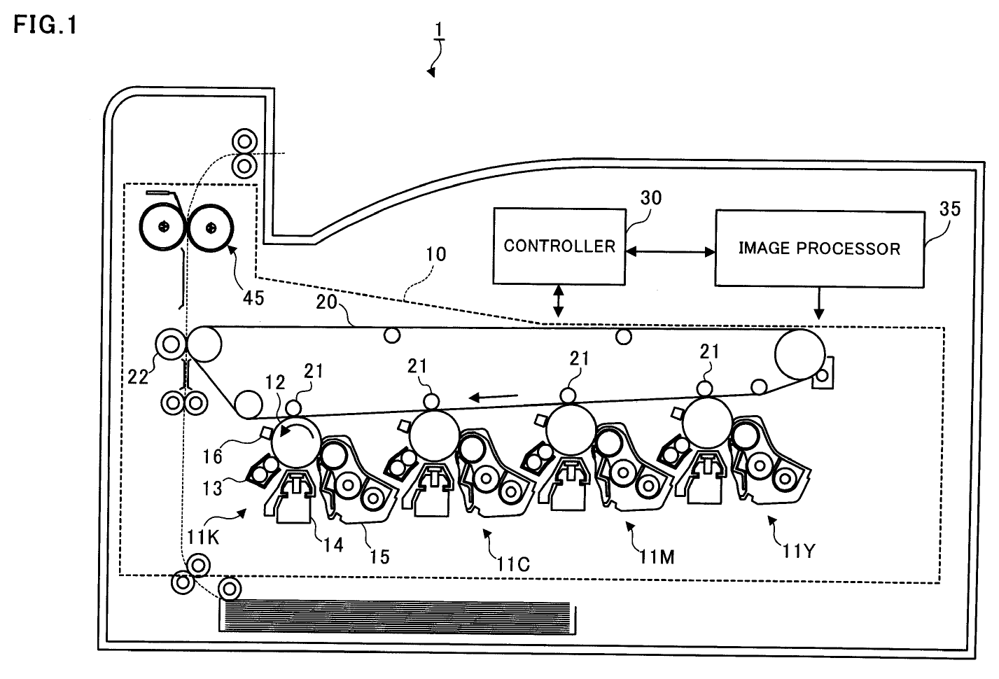

FIG. 1 shows an example of an overall configuration of an image forming apparatus 1 to which the exemplary embodiment is applied. The image forming apparatus 1 includes an image formation processor 10, a controller 30 and an image processor 35. The image formation processor 10 forms images respectively corresponding to respective color image datasets. The controller 30 controls the operations of the entire image forming apparatus 1. The image processor 35, which is connected to external devices (not shown in the figure) such as a personal computer and an image reading apparatus, performs image processing on image data received from these external devices.

The image formation processor 10 includes four image forming units 11 (11Y, 11M, 11C and 11K, specifically) placed at intervals. Each of the image forming units 11 includes a photoconductor drum 12, a charging device 13, a LED print head (LPH) 14, a developing device 15 and a cleaner 16. The photoconductor drum 12 is an example of an image carrier. The charging device 13 charges the photoconductor drum 12. The LPH 14 exposes the charged photoconductor drum 12 in accordance with image datasets transmitted from the image processor 35. The developing device 15 develops an electrostatic latent image formed on the photoconductor drum 12 with toner. The cleaner 16 cleans the surface of the photoconductor drum 12. Note that the image forming units 11 form yellow (Y), magenta (M), cyan (C) and black (K) toner images, respectively.

In addition, the image formation processor 10 further includes an intermediate transfer belt 20, primary transfer rolls 21, a secondary transfer roll 22 and a fixing device 45. The intermediate transfer belt 20 circulates while facing the photoconductor drums 12 of the image forming units 11. The primary transfer rolls 21 are placed facing the respective photoconductor drums 12 of the image forming units 11 with the intermediate transfer belt 20 interposed therebetween. Each primary transfer roll 21 primarily transfers a toner image formed on the corresponding photoconductor drum 12 onto the intermediate transfer belt 20. The secondary transfer roll 22, which is placed facing the intermediate transfer belt 20, secondarily transfers, onto a paper sheet, color toner images superposedly transferred on the intermediate transfer belt 20. The fixing device 45 heats and presses to fix toner images that have been secondarily transferred but are unfixed on a paper sheet.

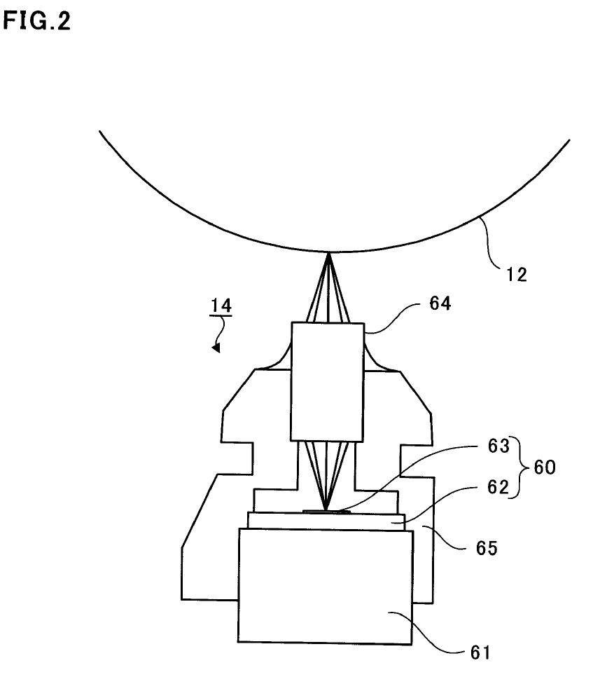

FIG. 2 is a cross-sectional view showing a structure of the LPH 14. The LPH 14 includes a housing 61, a light-emitting portion 63, a circuit board 62, a rod lens array 64 and a holder 65. The light-emitting portion 63 includes multiple LEDs. The circuit board 62, on which the light-emitting portion 63 is mounted, is attached to the housing 61. The rod lens array 64 focuses light emitted by the light-emitting portion 63 onto the surface of the photoconductor drum 12. The holder 65, which is fitted over the housing 61, supports the rod lens array 64 and shields the light-emitting portion 63 from the outside. Note that, in the following description, the circuit board 62 and the light-emitting portion 63 mounted thereon will be collectively referred to as a light-emitting unit 60.

The housing 61 is made of, for example, a metal, and supports the circuit board 62. The rod lens array 64 is placed parallel to the shaft of the photoconductor drum 12 and has a certain width in a rotation direction of the photoconductor drum 12. The holder 65 is placed parallel to the shaft of the photoconductor drum 12 and shields the light-emitting portion 63. The holder 65 holds the housing 61 and the rod lens array 64 so that light-emitting points of the light-emitting portion 63 are located in the focal plane of the rod lens array 64.

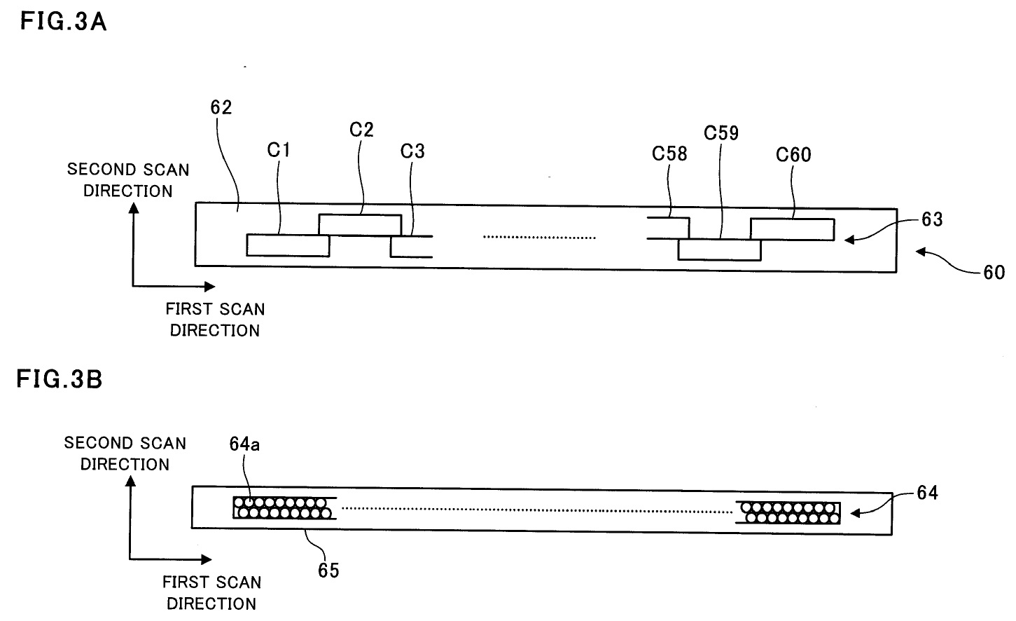

FIG. 3A is a top view of the light-emitting unit 60 of the LPH 14 while FIG. 3B is a top view of the rod lens array 64 and the holder 65 of the LPH 14. As shown in FIG. 3A, the light-emitting portion 63 is formed of 60 light-emitting chips C (C1 to C60) zigzag arrayed on the circuit board 62 in two lines in a second scan direction. Here, the light-emitting chips C are an example of a light-emitting device.

Each of the light-emitting chips C1 to C60 includes 256 LEDs mounted thereon as will be described later, and thus the light-emitting portion 63 is provided with 15360 LEDs in total. In addition, the distance from the outer end of the light-emitting chip C1 to the outer end of the light-emitting chip C60 (the length of the light-emitting portion 63 in a first scan direction) is set to 324 mm so as to allow image formation on A3 plus size paper sheets. To achieve this arrangement, the LEDs are arrayed at equal pitches of approximately 21.15 μm. As a result, the LPH 14 to which the present exemplary embodiment is applied has a resolution of 1200 dot per inch (dpi) in the first scan direction.

Meanwhile, as shown in FIG. 3B, the rod lens array 64 is formed of multiple rod lenses 64a staggeredly arrayed in two lines stacked in the second scan direction and held by the holder 65. Each rod lens 64a may be a gradient index lens having a cylindrical shape, and a refractive-index distribution in the radial direction thereof to form an upright real image at the same magnification, for example. Examples of such gradient index lenses include a SELFOC (registered trademark of Nippon Sheet Glass Co., Ltd.) lens array.

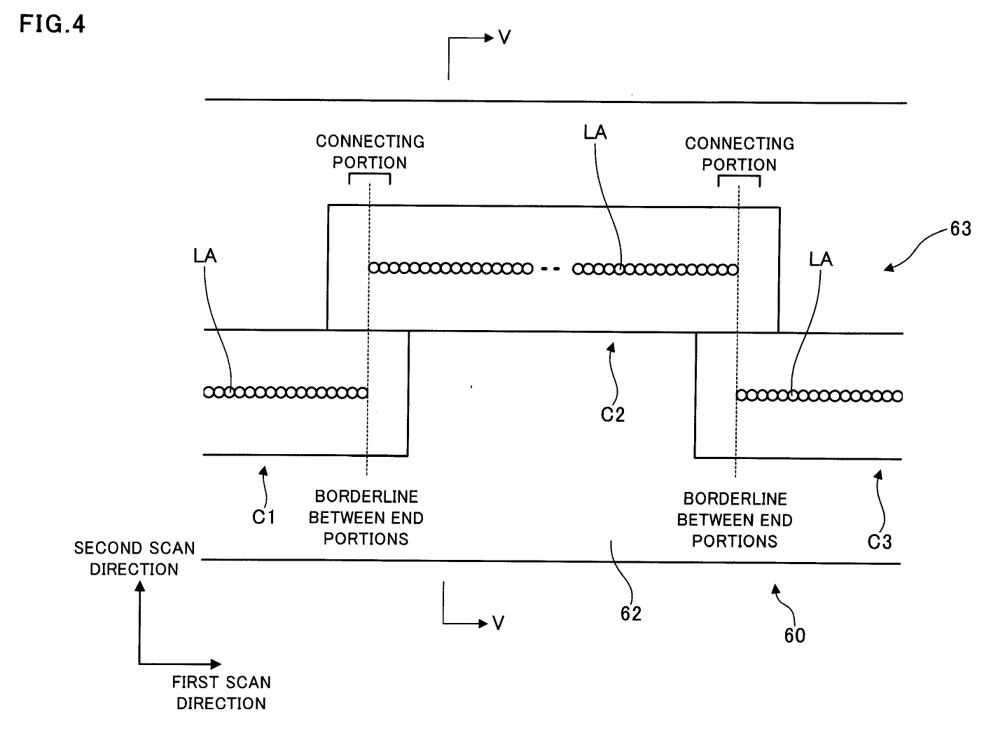

FIG. 4 is an enlarged view of a region in which the light-emitting chips C1, C2 and C3 are connected in the light-emitting portion 63 of the light-emitting unit 60. Here, each of the light-emitting chips C1 to C60 has the same structure that includes a LED array LA formed of 256 LEDs arrayed in a line extending in the first scan direction. As shown in FIG. 4, the LED arrays LA are arranged to be consecutive in the first scan direction at connecting portions between the light-emitting chips C1 and C2 and between the light-emitting chips C2 and C3 around the borderlines between end portions of the light-emitting chips C1 and C2 and between the light-emitting chips C2 and C3.

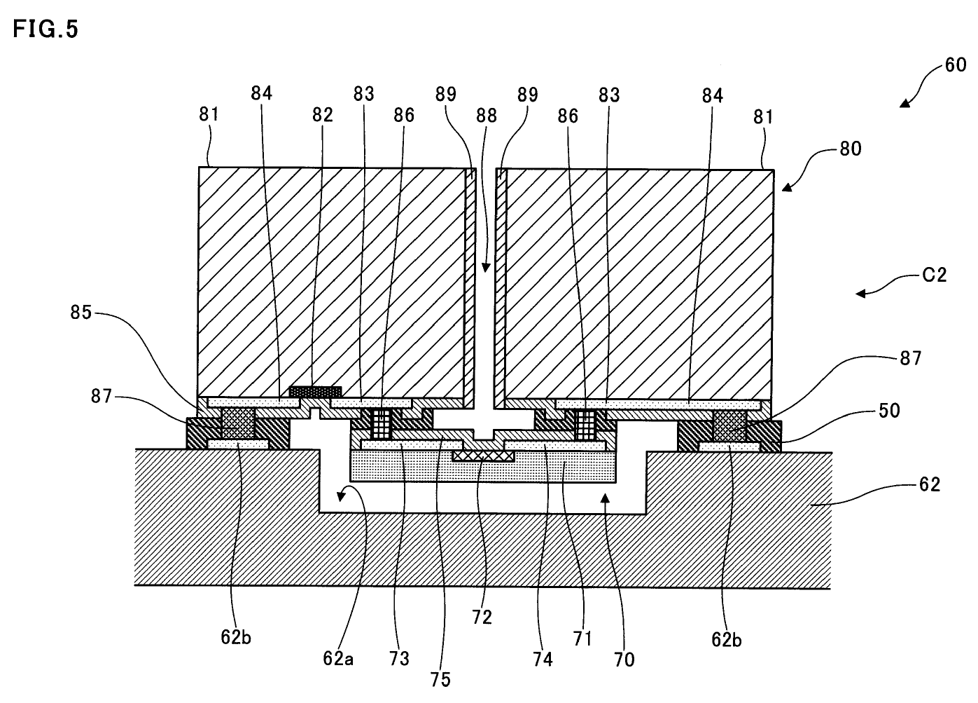

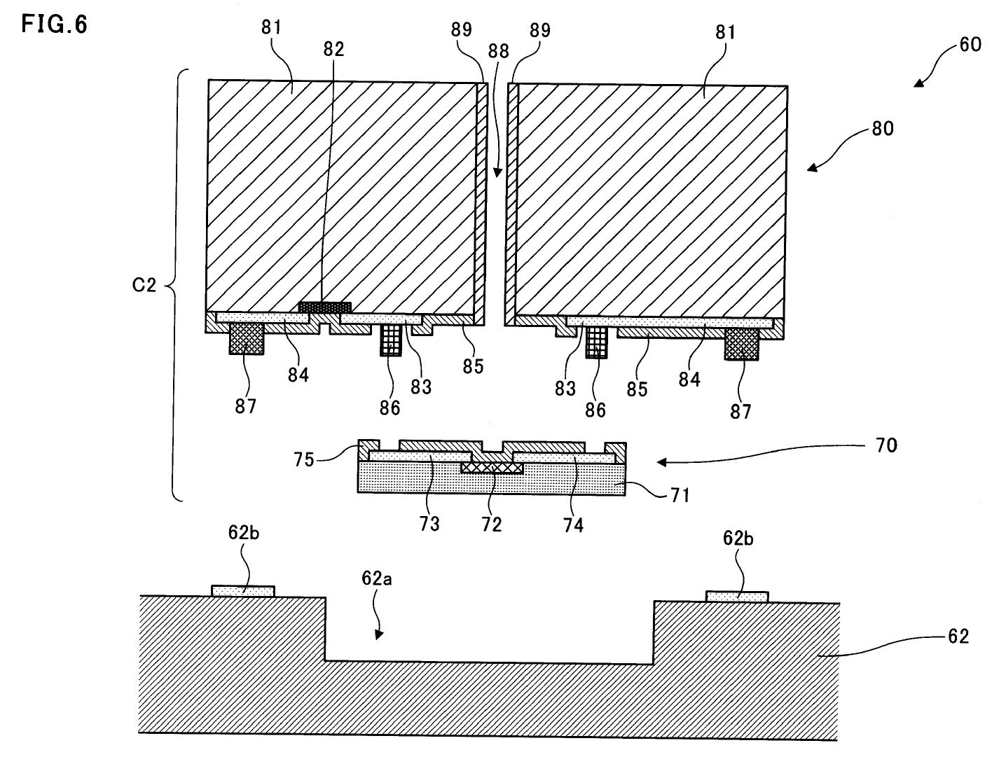

FIG. 5 is a cross-sectional view of the light-emitting unit 60 taken along the V-V line of FIG. 4, that is, in a region where the light-emitting chip C2 is mounted. Meanwhile, FIG. 6 is an exploded cross-sectional view of the light-emitting unit 60 in the region where the light-emitting chip C2 is mounted. Note that the other light-emitting chips C1 and C3 to C60 have the same structure as the light-emitting chip C2. Thus, the following description will be given by assuming the light-emitting chip C2 as the light-emitting chip C.

The circuit board 62 included in the light-emitting unit 60 as an example of an exposure device is, for example, a printed circuit board which is a so-called glass-epoxy substrate with wiring (not shown in the figure) formed therein and on the front and back surfaces thereof. The glass-epoxy substrate includes, as a base, a glass fabric board impregnated with epoxy resin. In addition, the circuit board 62 has concave portions 62a formed on the side facing the light-emitting chips C. The concave portions 62a are formed so that light-emitting element chips 70 of the light-emitting chips Care packed thereon. Accordingly, in the circuit board 62, the number of the formed concave portions 62a is the same as that of the light-emitting chips C (60 chips). By forming the concave portions 62a in the circuit board 62, the light-emitting unit 60 formed of the circuit board 62 and the light-emitting chips C mounted thereon is thinner as compared to the case where the concave portions 62a are not formed. In place of the concave portions 62a, penetration holes may be formed in the circuit board 62. In addition, electrode pads 62b are formed outside of both edges of each concave portion 62a of the circuit board 62, respectively. The electrode pads 62b is electrically connected to the wiring formed in the circuit board 62 so as to be electrically connected to a drive element chip 80 of the light-emitting chip C. In the following description, among the surfaces of the circuit board 62, the surface where the electrode pads 62b are formed may be referred to as a connection surface.

Each light-emitting chip C includes the light-emitting element chip 70 in which the LED array LA is formed, and the drive element chip 80 in which a drive circuit 82 for driving the LED array LA is formed. In the present exemplary embodiment, each light-emitting chip C is formed by bonding the light-emitting element chip 70 to the drive element chip 80 with non-conductive paste (NCP) 50. Moreover, each light-emitting unit 60 is formed by bonding the drive element chips 80 of the respective light-emitting chips C (C1 to C60) to the circuit board 62 with NCP 50.

Here, each light-emitting element chip 70 includes a light-emission substrate 71, LEDs 72, wiring parts 73 and 74, and a protective film 75. The light-emission substrate 71 as an example of a first substrate is formed of a GaAs-based compound semiconductor. The LEDs 72 as an example of light-emitting elements are formed by stacking p-type layers and n-type layers on the light-emission substrate 71. The wiring parts 73 and 74 are formed on the light-emission substrate 71, and each of the wiring parts 73 and 74 is electrically connected to the LEDs 72. The protective film 75 is formed of, for example, SiO₂, and covers the light-emission substrate 71, the LEDs 72 and the wiring parts 73 and 74, except some parts of the wiring parts 73 and 74. Note that, in the light-emitting element chip 70, the 256 LEDs 72 are arrayed in a line from the front side to the back side of FIGS. 5 and 6, and thus form the LED array LA. In the following description, among the surfaces of the light-emitting element chip 70, the surface where the LEDs 72 are formed will be referred to as light-emitting surface (equivalent to one surface of the first substrate).

Meanwhile, the drive element chip 80 includes a drive substrate 81, penetration holes (portions defining penetration holes) 88 and reflective films 89. The drive substrate 81 as an example of a second substrate is formed of a Si-based semiconductor. The penetration holes 88 are formed to penetrate the drive element chip 80 at positions that face the respective LEDs 72 of the light-emitting element chip 70 when the light-emitting chip C is fabricated. The reflective films 89 as an example of a reflective member are formed on the inner surfaces of the respective penetration holes 88. Note that the penetration holes 88 are provided for the respective LEDs 72. Thus, in each drive substrate 81, formed are the penetration holes 88 as many as the LEDs 72 (256 LEDs) provided in each light-emitting element chip 70. Here, the inside diameter of each penetration hole 88 with the reflective film 89 formed therein is set to on the order of 10 to 20 μm, and the length of the penetration hole 88 is set to on the order of 200 to 300 μm. Note that each reflective film 89 is a thin film made of a metal such as aluminum or silver, or an oxide such as SiO₂, for example. However, the reflective films 89 are not necessarily formed. Instead, silicon may be exposed through the inner surfaces of the penetration holes 88. In addition, though each penetration hole 88 is cylindrical in the present exemplary embodiment, the dimensional design thereof may be changed. Moreover, the number of the penetration holes 88 may be reduced to one by forming an elongate hole along the LED array LA as a collective form of the penetration holes 88.

In addition, the drive element chip 80 further includes the drive circuit 82, wiring parts 83 and 84, and a protective film 85. The drive circuit 82 is formed by stacking p-type layers and n-type layers on the drive substrate 81 in a region at one side of the penetration holes 88 (the left side of FIGS. 5 and 6). The wiring parts 83 and 84 are formed on the drive substrate 81. The protective film 85 is formed of, for example, SiO₂, and covers the drive substrate 81, the drive circuit 82 and the wiring parts 83 and 84, except some parts of the wiring parts 83 and 84. Here, the drive circuit 82 is formed of combination of drive elements each having a so-called metal oxide semiconductor (MOS) structure, such as MOS transistors. The MOS structure is a layer structure formed sequentially of metal, insulator and semiconductor layers.

Moreover, the drive element chip 80 further includes first bumps 86 and second bumps 87. The first bumps 86 are formed in exposed portions of the wiring parts 83, respectively. Here, the wiring parts 83 are provided at both sides of the penetration holes 88, respectively, and each exposed portion thereof is a portion not covered with the protective film 85. The second bumps 87 are formed in exposed portions of the wiring parts 84, respectively. Here, the wiring parts 84 are provided at both sides of the penetration holes 88, and each exposed portion thereof is a portion not covered with the protective film 85. The first bumps 86 as an example of a connecting member or a first connecting member, which are provided to the drive element chip 80, are electrically connected to the respective wiring parts 73 and 74 provided to the light-emitting element chip 70, when the light-emitting chip C is fabricated. Meanwhile, the second bumps 87 as an example of a second connecting member, which is provided to the drive element chip 80, are electrically connected to the respective electrode pads 62b provided to the circuit board 62 when the light-emitting unit 60 is fabricated. Here, each first bump 86 functions as a protruding electrode and each second bump 87 functions as a different protruding electrode. Note that, in the following description, among the surfaces of the drive element chip 80, the surface where the first and second bumps 86 and 87 are formed may be referred to as a mount surface (equivalent to a mounting surface of the drive element chip).

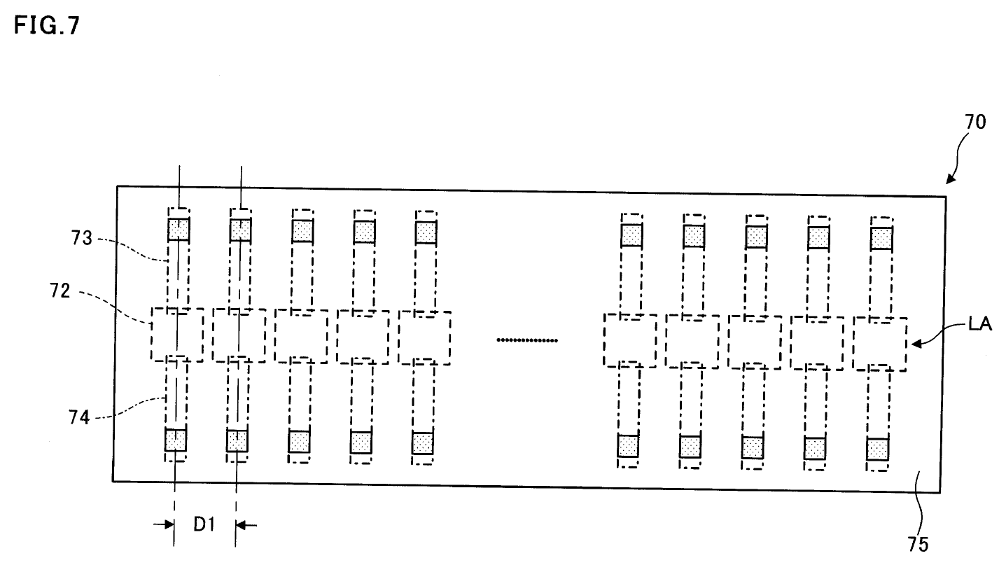

Here, FIG. 7 shows the light-emitting element chip 70 viewed from the light-emitting surface side. The 256 LEDs 72 are formed to be arrayed in a line on the light-emitting surface of the light-emitting element chip 70, and thus form the LED array LA. In addition, each LED 72 is connected to the corresponding wiring parts 73 and 74 at its anode and cathode, respectively.

In the light-emitting element chip 70, the pitch between any two adjacent LEDs 72 is set to a first pitch D1. If the resolution in the first scan direction is set to 1200 dpi, the first pitch D1 is approximately 21.15 μm, as described above. In addition, in the present exemplary embodiment, the pitch between any two adjacent wiring parts 73 and the pitch between any two adjacent wiring parts 74 are also set to the first pitch D1.

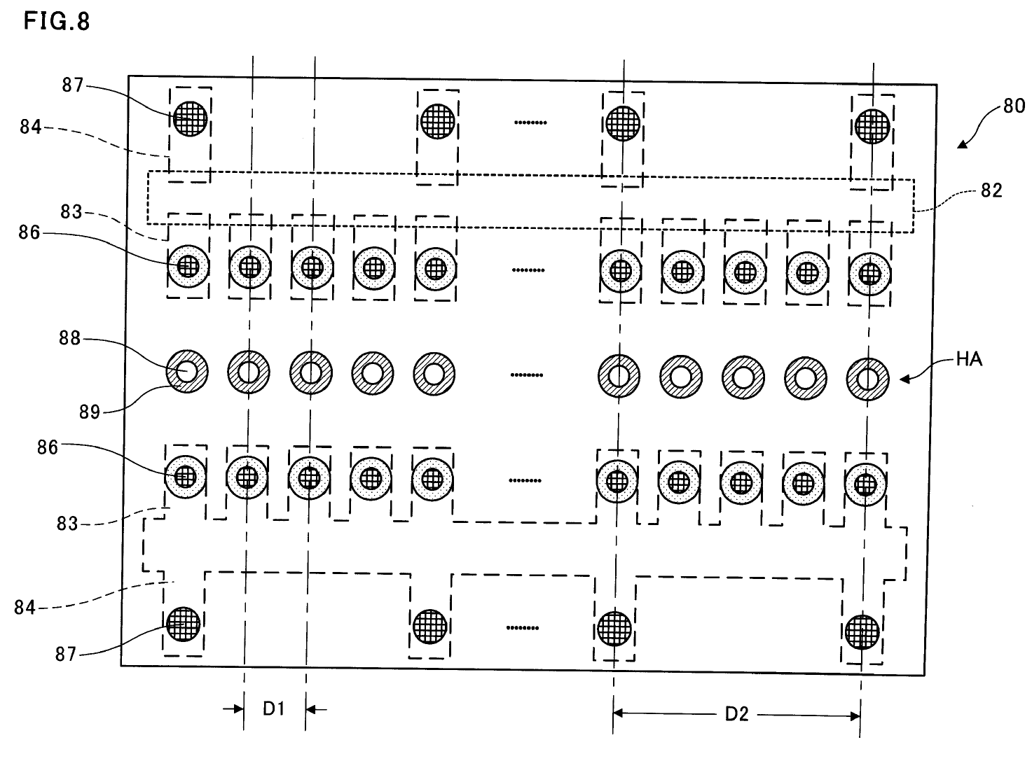

Meanwhile, FIG. 8 shows the drive element chip 80 viewed from the mount surface side. Through the mount surface side and the opposite side of the drive element chip 80, the 256 penetration holes 88 are formed so as to be arrayed in a line, and they form a penetration hole array HA. At each of the both sides of the penetration hole array HA, the 256 first bumps 86 are formed. The 256 first bumps 86 provided at one side of the penetration hole array HA as well as the 256 first bumps 86 provided at the other side of the penetration hole array HA are arrayed along the penetration hole array HA. In addition, the multiple second bumps 87 are formed at outer side of the 256 first bumps 86 provided at the one side of the penetration hole array HA, and the multiple second bumps 87 are formed at outer side of the 256 first bumps 86 provided at the other side of the penetration hole array HA as well. Here, the second bumps 87 formed at the one side of the penetration hole array HA are less than the first bumps 86 (256 bumps) formed at this side. Meanwhile, the second bumps 87 formed at the other side of the penetration hole array HA are also less than the first bumps 86 (256 bumps) formed at this side. Note that each first bump 86 provided in the upper part of FIG. 8 is connected to the drive circuit 82 through the corresponding wiring part 83, and each second bump 87 provided in the upper part of FIG. 8 is connected to the drive circuit 82 through the corresponding wiring part 84. Meanwhile, each first bump 86 provided in the lower part of FIG. 8 is connected to shared wiring through the corresponding wiring part 83, and each second bump 87 provided in the lower part of FIG. 8 is connected to the shared wiring through the corresponding wiring part 84. Thereby, the first bumps 86 and the second bumps 87 provided in the lower part of FIG. 8 are grounded.

In the drive element chip 80, the pitch between any two adjacent penetration holes 88 is set to the first pitch D1 as described above. In addition, the pitch between any two adjacent first bumps 86 is also set to the first pitch D1 as described above. On the other hand, the pitch between any two adjacent second bumps 87 is set to a second pitch D2, which is larger than the foregoing first pitch D1. Note that the second pitch D2 may be set to 100 μm or more, for example.

Hereinafter, a brief description will be given of a manufacturing procedure of the light-emitting chip C using the light-emitting element chip 70 and the drive element chip 80.

Firstly, the LEDs 72, the wiring parts 73 and 74, and the protective film 75 are formed on the light-emission substrate 71 made of a GaAs-based semiconductor through a known semiconductor process, and thereby the light-emitting element chip 70 is obtained. Meanwhile, the drive circuit 82, the wiring parts 83 and 84, the protective film 85, the first bumps 86, the second bumps 87, the penetration holes 88, and the reflective films 89 are formed on the drive substrate 81 made of a Si-based semiconductor through a known semiconductor process, and thereby the drive element chip 80 is obtained.

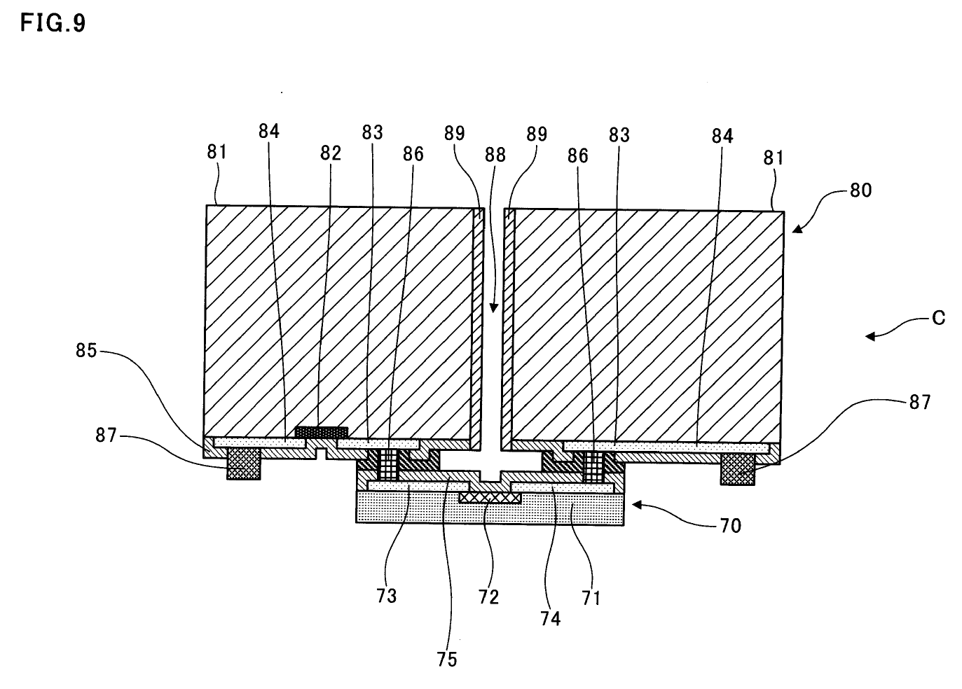

Then, the NCP 50 is placed on the exposed portions of the respective wiring parts 73 and 74 provided on the light-emitting surface of the light-emitting element chip 70 thus obtained. Subsequently, the light-emitting surface of the light-emitting element chip 70 is caused to face the mount surface of the drive element chip 80. At the same time, the multiple first bumps 86 provided to the drive element chip 80 are placed and fixed respectively onto the exposed portions of the multiple wiring parts 73 and 74 provided to the light-emitting element chip 70, in other words, onto the portions where the NCP 50 are placed. When the light-emitting element chip 70 and the drive element chip 80 are heated and pressed under these conditions, the first bumps 86 provided to the drive element chip 80 are brought into contact with the respective wiring parts 73 and 74 provided to the light-emitting element chip 70, and then the NCP 50 therebetween is cured. Thereby, the light-emitting element chip 70 and the drive element chip 80 are integrated, and thus the light-emitting chip C is obtained. In other words, the light-emitting element chip 70 is electrically connected and fixed to the drive element chip 80 by so-called flip-chip bonding, in this example. FIG. 9 is a cross-sectional view of the light-emitting chip C thus obtained.

Then, a brief description will be given of a manufacturing procedure of the light-emitting unit 60 using the multiple light-emitting chips C (C1 to C60) each obtained as above and the circuit board 62.

Firstly, the 60 light-emitting chips C are obtained by the aforementioned procedure. Meanwhile, the circuit board 62 with the 60 concave portions 62a and the multiple electrode pads 62b formed is obtained by a known manufacturing method.

Then, the NCP 50 is placed on the electrode pads 62b of the circuit board 62 thus obtained. Subsequently, the connection surface of the circuit board 62 is caused to face the mount surfaces of the drive element chips 80 of the light-emitting chips C. At the same time, the multiple second bumps 87 provided to the drive element chips 80 of the light-emitting chips C are placed and fixed respectively onto portions of the circuit board 62 where the multiple electrode pads 62b are formed, in other words, onto the portions where the NCP 50 are placed. When the circuit board 62 and the multiple light-emitting chips C are heated and pressed under these conditions, the second bumps 87 provided to the drive element chips 80 of the light-emitting chips C are brought into contact with the respective electrode pads 62b provided to the circuit board 62, and then the NCP 50 therebetween is cured. Thereby, the 60 light-emitting chips C (C1 to C60) and the circuit board 62 are integrated, and thus the light-emitting unit 60 is obtained. In other words, the light-emitting chips C are electrically connected and fixed to the circuit board 62 by so-called flip-chip bonding, in this example. The light-emitting unit 60 thus obtained has a cross section shown in foregoing FIG. 5.

As described above, in the present exemplary embodiment, the light-emitting element chip 70 and the drive element chip 80, which form each light-emitting chip C, are connected by flip-chip bonding, and then the multiple light-emitting chips C and the circuit board 62, which form the light-emitting unit 60, are also connected by flip-chip bonding.

Next, a description will be given of an operation of each LPH 14 used in the present exemplary embodiment.

Upon start of an image forming operation of the image forming apparatus 1, the image processor 35 performs image processing on received data and outputs the resultant image datasets to each LPH 14. Note that the image processor 35 outputs image datasets for the individual light-emitting chips C1 to C60 to the 60 light-emitting chips C1 to C60 constituting the light-emitting unit 60 of each LPH 14, respectively in this example. However, if, for example, the light-emitting unit 60 is equipped with a circuit such as an application specific integrated circuit (ASIC), the image processor 35 may output, to the ASIC, image datasets for all the light-emitting chips in the light-emitting unit 60. In this case, the ASIC outputs the image datasets for the individual light-emitting chips C1 to C60 to the 60 light-emitting chips C1 to C60, respectively.

Then, for example, in the light-emitting chip C2 as one of 60 light-emitting chips C1 to C60, the circuit board 62 receives the image dataset for the light-emitting chip C2, and forwards the received image dataset to the drive element chip 80 of the light-emitting chip C2. To be more specific, the circuit board 62 outputs the thus-received individual image dataset to the drive circuit 82 of the drive element chip 80 of the light-emitting chip C2 through wiring not shown in the figure, the electrode pads 62b, the second bumps 87 and the wiring parts 84.

On the basis of the individual image dataset thus received, the drive circuit 82 of the drive element chip 80 performs arithmetic computation to determine which of the 256 LEDs 72 constituting the LED array LA of its light-emitting element chip 70 is set to emit light, how high light intensity (a current value or a light-emitting period) is assigned to each of the LEDs 72 that are set to emit light, and the like. Then, the drive circuit 82 outputs, to the light-emitting element chip 70, control signals for the individual LEDs 72, obtained as a result of this arithmetic computation. To be more specific, the drive circuit 82 outputs the individual control signals to the respective LEDs 72 of the light-emitting element chip 70 through the wiring parts 83, the first bumps 86 formed on the respective wiring parts 83, and the wiring parts 73 and 74 corresponding to the respective first bumps 86. Note that, in addition to the above arithmetic computation on light emission of the LEDs 72, the drive circuit 82 may perform arithmetic computation on another operation.

Each of the 256 LEDs 72 provided to the light-emitting element chip 70 is set either to emit light or not to emit light, in accordance with the individual control signal transmitted to the LED 72. For example, suppose that each LED 72 is connected to the corresponding wiring parts 73 and 74 at its anode and cathode, respectively. In this case, if a certain one of the wiring parts 74 is set to a low level while the wiring part 73 corresponding to the certain wiring part 74 is set to a high level, the LED 72 connected to these wiring parts 73 and 74 emits light. On the other hand, if a certain one of the wiring parts 74 is set to the low level while the wiring part 73 corresponding to the certain wiring part 74 is set to the low level, the LED 72 connected to these wiring parts 73 and 74 does not emit light. Note that the individual control signals transmitted to the light-emitting element chip 70 by the drive element chip 80 may cause all the selected ones of the 256 LEDs 72 constituting the light-emitting element chip 70 to simultaneously emit light, or may cause the selected ones of the 256 LEDs 72 constituting the light-emitting element chip 70 to sequentially emit light. Specifically, when this sequential light emission is employed, one LED 72 may emit light at a time, or two or more LEDs 72 may emit light at a time.

When the selected ones of the LEDs 72 provided to the light-emitting element chip 70 emit light, the light beams emitted by these LEDs 72 pass through the penetration holes 88, which are provided to the drive element chip 80 so as to correspond to the respective LEDs 72. After that, the light beams further pass through the rod lens array 64, and then the photoconductor drum 12 is irradiated with the light beams.

Note that a similar operation to above is performed on each of the other light-emitting chips C1 and C3 to C60. Thus, the light-emitting chips C1 and C3 to C60 each receive the individual image dataset, and perform light emission control on the 256 LEDs 72 constituting the LED array LA therein on the basis of the received image dataset.

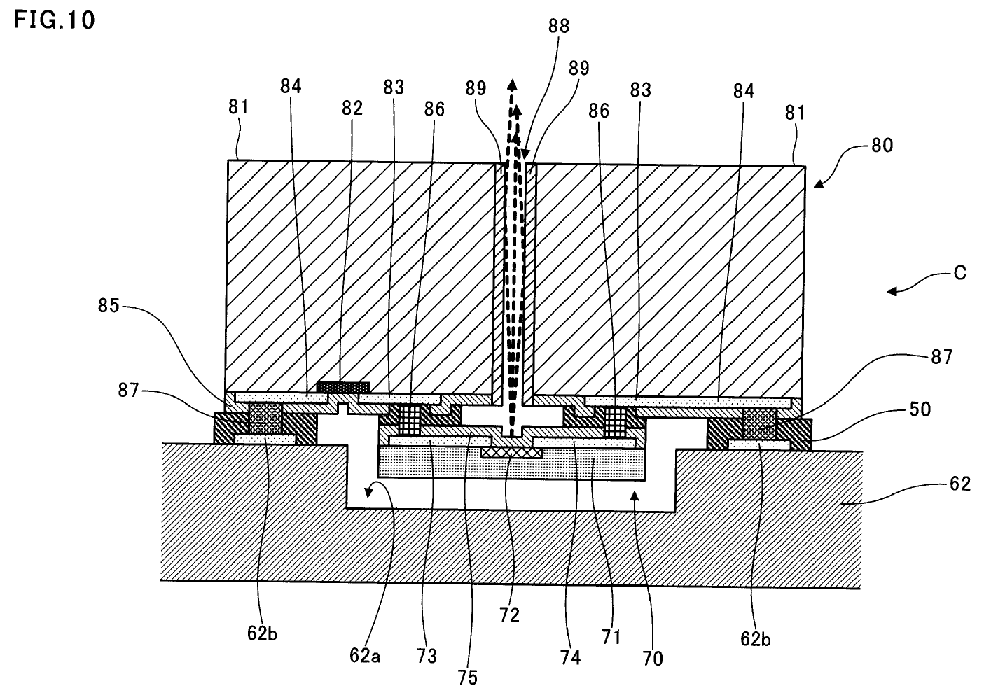

Incidentally, FIG. 10 shows light paths of the light beams emitted by one of the LEDs 72 provided to the light-emitting element chip 70 in the light-emitting chip C. Note that the light beams emitted by the LED 72 are indicated by the dashed arrows in FIG. 10.

As described above, the light beams emitted by each LED 72 are outputted through the corresponding penetration hole 88. Here, each LED 72 inherently has characteristics of emitting three-dimensionally expanding light. However, the light emitted by the LED 72 is outputted to the outside through the penetration hole 88 in the present exemplary embodiment. Accordingly, the expansion of the light is suppressed, which improves the light collection capability of the image forming apparatus 1. Moreover, the reflective films 89 are formed on the inner surfaces of the penetration holes 88 in the present exemplary embodiment. Accordingly, even light beams that incident obliquely with respect to the penetration hole 88 are outputted to the outside after being reflected by the reflective film 89 therein, which improves the light extraction efficiency in the image forming apparatus 1. In addition, the 256 penetration holes 88 are provided to the drive element chip 80 so as to correspond to the respective 256 LEDs 72 provided to the light-emitting element chip 70 in the present exemplary embodiment. Accordingly, the two dimensional expansion of light emitted by each LED 72 is also suppressed, which improves the light collection capability of the image forming apparatus 1 much more.

Moreover, in the present exemplary embodiment, not wire bonding but flip-chip bonding is used for connecting the multiple light-emitting chips C to the circuit board 62 to form the light-emitting unit 60 as well as for connecting the light-emitting element chip 70 to the drive element chip 80 to form each light-emitting chip C, as described above. This prevents stray light, which would occur when the light outputted from each LED 72 is reflected by wire used for bonding.

Note that, in the drive element chip 80 used in the present exemplary embodiment, the pitch between any two adjacent first bumps 86 is set to the first pitch D1 while the pitch between any two adjacent second bumps 87 is set to the second pitch D2, which is larger than the first pitch D1, for the following reasons.

In the present exemplary embodiment, the drive element chip 80 provided to each light-emitting chip C receives an individual image dataset from the image processor 35 provided to the image forming apparatus 1, and causes the drive circuit 82 therein to perform arithmetic computation by using the individual image dataset thus received. Thereby, the drive element chip 80 generates and outputs individual control signals for the 256 LEDs 72 provided to the light-emitting element chip 70 of this light-emitting chip C.

In addition, in the present exemplary embodiment, the light-emitting element chip 70 of each light-emitting chip C includes the 256 LEDs 72 and the wiring parts 73 and 74, each of which is connected to the LEDs 72, and thus has 256 terminals on each side of the 256 LEDs 72, in other words, 512 terminals in total. Accordingly, in the light-emitting chip C, the drive element chip 80 needs to output the individual control signals to the LEDs 72 of the light-emitting element chip 70, respectively.

Meanwhile, in the present exemplary embodiment, the light-emitting element chip 70 and the drive element chip 80 are each formed of a semiconductor substrate while the circuit board 62 is formed of a printed circuit board. Accordingly, the light-emitting element chip 70 and the drive element chip 80 may be processed with the higher degree of accuracy than the circuit board 62 formed of the printed circuit board. Meanwhile, in the light-emitting element chip 70 in the present exemplary embodiment, the pitches between any two adjacent LEDs 72, between any two adjacent wiring parts 73, and between any two adjacent wiring parts 74 are all set to the first pitch D1 (approximately 21.15 μm in this example). Accordingly, the first bumps 86, which are provided to the drive element chip 80 to be used for connecting the drive element chip 80 to the light-emitting element chip 70, are also arrayed at the first pitches D1.

On the other hand, between the circuit board 62 and the drive element chips 80 of the light-emitting chips C, connected are: signal lines for receiving the foregoing individual image datasets; and power lines for driving the drive circuits 82 of the drive element chips 80 as well as for causing the LEDs 72 of the light-emitting element chips 70 to emit light. The required number of signal lines for each light-emitting chip C is only a few, that is, much smaller than the number of the LEDs 72 provided to the light-emitting chip C. In addition, the required number of power lines is still smaller than that of the signal lines. Accordingly, the second bumps 87, which are provided to each drive element chip 80 to be used for connecting the drive element chip 80 to the circuit board 62, may be less than the first bumps 86. Therefore, the pitch between any two adjacent second bumps 87 may be the second pitch D2, which is larger than the first pitch D1, that is, the pitch between any two adjacent first bumps 86. In addition, as described above, since the circuit board 62 is formed of the printed circuit board, the circuit board 62 is processed with the less degree of accuracy than the light-emitting element chip 70 and the drive element chip 80 which are each formed of a semiconductor substrate. This makes it difficult to process the circuit board 62 at an accuracy of the first pitch D1. Thus, the second pitch D2 may be larger than the first pitch D1 from this viewpoint as well.

Note that, though the first bumps 86 and the second bumps 87 are formed on the drive element chips 80 in the present exemplary embodiment, the present invention is not limited to this. Instead, the first bumps 86 may be formed on the light-emitting element chips 70, and the second bumps 87 may be formed on the circuit board 62, for example.

Moreover, in the present exemplary embodiment, each light-emitting chip C is formed by integrating the light-emitting element chip 70 and the drive element chip 80 by flip-chip bonding, and the drive element chips 80 of the light-emitting chips C and the circuit board 62 are integrated by flip-chip bonding, too. However, connection methods used here may be changed in accordance with the designs.

Furthermore, though the light-emission substrate 71 used in each light-emitting element chip 70 is a GaAs-based semiconductor substrate in the present exemplary embodiment, the present invention is not limited to this. Instead, the light-emission substrate 71 may be made of any of various compound semiconductors used for forming the LEDs 72.

In addition, though the LEDs 72 are used as the light-emitting elements in the present exemplary embodiment, the present invention is not limited to this. Instead, semiconductor laser elements or organic EL elements may be used as the light-emitting elements.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An exposure device that exposes a charged image carrier, comprising:
a light-emitting chip on which a plurality of light-emitting elements are arrayed in a first scan direction; and
a circuit board on which the light-emitting chip is mounted, the circuit board including wiring electrically connected to the light-emitting chip,
the light-emitting chip including:
a light-emitting element chip that includes a first substrate and the plurality of light-emitting elements formed on one surface of the first substrate;
a drive element chip that includes a second substrate, a drive element formed on the second substrate and a portion defining a penetration hole formed in the second substrate, the drive element driving the plurality of light-emitting elements provided to the light-emitting element chip;
a first connecting member that electrically connects the plurality of light-emitting elements provided on the one surface of the first substrate of the light-emitting element chip to the drive element provided to the drive element chip, in a state where the plurality of light-emitting elements face the portion defining the penetration hole formed in the drive element chip; and
a second connecting member that electrically connects the drive element provided to the drive element chip to the wiring provided to the circuit board, in a state where a mounting surface of the drive element chip faces the circuit board, the light-emitting element chip being fixed to the mounting surface.

2. The exposure device according to claim 1, wherein
the light-emitting element chip and the drive element chip forming the light-emitting chip are flip-chip bonded with the first connecting member, and
the drive element chip included in the light-emitting chip, and the circuit board are flip-chip bonded with the second connecting member.

3. The exposure device according to claim 1, wherein the drive element chip includes a plurality of the portions defining penetration holes as many as the plurality of light-emitting elements provided to the light-emitting element chip.

4. The exposure device according to claim 1, further comprising a reflective member that is provided on an inner wall of the portion defining the penetration hole provided in the drive element chip, and that reflects light emitted by the plurality of light-emitting elements provided to the light-emitting element chip.

5. The exposure device according to claim 1, wherein
the circuit board is formed of a printed circuit board,
the light-emitting chip is provided with a plurality of the first connecting members and a plurality of the second connecting members, and
the number of the second connecting members is set to be less than the number of the first connecting members while a pitch between any two adjacent second connecting members is set to be larger than a pitch between any two adjacent first connecting members.

6. A light-emitting device comprising:
a light-emitting element chip that includes a first substrate and a plurality of light-emitting elements formed on one surface of the first substrate;
a drive element chip that includes a second substrate, a drive element formed on the second substrate and a portion defining a penetration hole formed in the second substrate, the drive element driving the plurality of light-emitting elements provided to the light-emitting element chip; and
a connecting member that electrically connects the plurality of light-emitting elements provided on the one surface of the first substrate of the light-emitting element chip to the drive element provided to the drive element chip, in a state where the plurality of light-emitting elements face the portion defining the penetration hole formed in the drive element chip.

7. The light-emitting device according to claim 6, wherein the light-emitting element chip and the drive element chip are flip-chip bonded with the connecting member.

8. The light-emitting device according to claim 6, further comprising a different protruding electrode, wherein
the connecting member is formed on one surface of the drive element chip and is formed of a protruding electrode that protrudes from the one surface of the drive element chip toward the light-emitting element chip, and
the different protruding electrode is formed on the one surface of the drive element chip, and protrudes from the one surface of the drive element chip toward another electrical circuit in order to electrically connect the drive element provided to the drive element chip to the another electrical circuit.

9. The light-emitting device according to claim 6, wherein
the first substrate of the light-emitting element chip is formed of a semiconductor substrate containing a compound semiconductor, and
the second substrate of the drive element chip is formed of a semiconductor substrate containing silicon.
